(19) United States
(12) Patent Application Publication
(10) Pub. No.: US 2020/0096813 A1
(43) Pub. Date: Mar. 26, 2020

(54) DISPLAY PANEL AND DISPLAY DEVICE

(71) Applicant: HKC CORPORATION LIMITED, Shenzhen (CN)

(72) Inventor: Beizhou Huang, Shenzhen (CN)

(21) Appl. No.: 16/312,501

(22) PCT Filed: Oct. 22, 2018
(86) PCT No.: PCT/CN2018/111260

§ 371 Date: Dec. 21, 2018

(30) Foreign Application Priority Data
Sep. 20, 2018 (CN) 20181102221.4
Sep. 20, 2018 (CN) 20181555478.0

(51) Int. Cl. G02F 1/1335; G02F 1/1339

(52) U.S. Cl. CPC G02F 1/133514; G02F 1/133512; G02F 1/1339; G02F 1/133528

(57) ABSTRACT

The present application discloses a display panel and a display device, which include a color filter substrate (3), a spacer (4), an array substrate (6), a first polarizer (2), and a black matrix (5) arranged on the first polarizer 2; the spacer (4) includes a main spacer (401) and a secondary spacer (402).

### CROSS-REFERENCE TO RELATED APPLICATION

This application is the International Application No. PCT/CN2018/111260 for entry into US national phase with an international filing date of Oct. 22, 2018 designating US, now pending, and claims priority to Chinese Patent Application No. 201811102221.4, filed on Sep. 20, 2018, the content of which is incorporated herein by reference in its entirety.

### TECHNICAL FIELD

The present application relates to the field of display, particularly to a display panel and a display device.

### BACKGROUND

With the development of material technologies, new panel materials have greatly promoted the technologies of the products. The two processes of BM (black matrix) and PS (photo spacer) may be combined into one process, and replaced with one new process, i.e., BM+PS, which is referred to as the process of BPS; PS is divided into two types, i.e., Main-PS (main spacer) and Sub-PS (secondary spacer), therefore, there are two segmental differences in the panel structure, namely, the segmental difference Y between the main spacer and the secondary spacer, and the segmental difference X between the secondary spacer and the black matrix; since the border is designed as a whole with large area, the height of the black matrix in contact with the border is hard to control, which causes the segmental difference X between the secondary spacer and each black matrix nonuniform, thus causing gaps of the panel nonuniform and affecting the quality of products.

### Technical Problem

The purpose of the present application is to provide a display panel and a display device, which aims at solving the problem that the segmental difference between the secondary spacer and each black matrix is nonuniform.

### SUMMARY

In order to achieve the above purpose, the technical solutions afforded by the present application reside in that: a display panel is provided, which includes:

a color filter substrate;

a spacer disposed on the surface of the color filter substrate, wherein the spacer comprises a main spacer and a secondary spacer;

an array substrate arranged opposite to the color filter substrate;

a first polarizer arranged on a side of the array substrate facing away from the color filter substrate; and

a black matrix arranged on a side of the first polarizer facing away from the array substrate.

Alternative purpose of the present application is to provide a display device, which includes:

a color filter substrate;

a spacer disposed on the surface of the color filter substrate, wherein the spacer comprises a main spacer and a secondary spacer;

an array substrate arranged opposite to the color filter substrate;

a first polarizer arranged on a side of the array substrate facing away from the color filter substrate;

a black matrix arranged on a side of the first polarizer facing away from the array substrate; and

a backlight module arranged on a side of the black matrix facing away from the first polarizer.

Alternative purpose of the present application is to provide a display panel, which includes:

a color filter substrate, the surface of which is provided with a transparent conductive film;

an array substrate arranged opposite to the color filter substrate, the surface of the array substrate is provided with an array substrate driving circuit and a color resistance, the surface of the color resistance is provided with a common electrode of the array substrate;

a first polarizer arranged on a side of the array substrate facing away from the color filter substrate;

a black matrix arranged on a side of the first polarizer facing away from the array substrate;

a second polarizer disposed on a side of the color filter substrate facing away from the array substrate; and

a spacer arranged on a side of the color filter substrate facing away from the second polarizer, wherein the spacer comprises a main spacer and a secondary spacer, the height of the main spacer is larger than the height of the secondary spacer, the transparent conductive film covers the spacer, and at least one main spacer pushes the transparent conductive film to be to be connected with the array substrate through the common electrode.

With regard to the display panel provided in the present application, the black matrix is arranged on the side of the first polarizer facing away from the array substrate, the BPS (BM+PS) in the inner side of the color filter substrate merely requires producing the main spacer and the secondary spacer, thus there is only one segmental difference between the main spacer and the secondary spacer in the inner side of the color filter substrate, and there is no segmental difference between the black matrix and the secondary spacer, i.e., the problem, that the segmental difference between the secondary spacer and the black matrix is nonuniform, is solved, thereby ensuring the gaps are uniform when the display panel is under different circumstances, and further improving the quality of the panel.

### BRIEF DESCRIPTION OF THE DRAWINGS

In order to more clearly illustrate the technical solutions in embodiments of the present application, the drawings used in the description of the embodiments or the prior art will be briefly described below. Obviously, the drawings in the following description are only some embodiments of the present application, and other drawings may be obtained based on these drawings without creative works for those ordinaries skilled in the art.

FIG. 1 is a structural schematic view of the display panel in one of embodiments of the present application.

FIG. 2 is a structural schematic view of the display panel in another embodiment of the present application.

FIG. 3 is a structural schematic view of the display device in an embodiment of the present application.

Herein:

1—second polarizer; 2—first polarizer; 3—color filter substrate; 4—spacer; 401—main spacer; 402—secondary spacer; 5—black matrix; 6—array substrate; 7—array substrate driving circuit; 8—liquid crystal; 9—transparent conductive film; 10—sealing frame; 11—TFT (Thin Film Transistor) array; 12—backlight module.

### ILLUSTRATIVE EMBODIMENTS

In order to more clearly illustrate the purpose, the technical solutions and the advantages of the present application, further details of the present application will be described below with reference to the drawings and the embodiments. It should be understood that, the specific embodiments described herein are merely provided to illustrate the present application, and not intended to limit the present application.

It should be noted that, when a component is referred to as “being fixed to” or “being arranged to” another component, the component may be directly on another component or indirectly on another component. When a component is referred to as “being connected to” another component, the component may be directly connected to another component or indirectly connected to another component.

It should be understood that, the orientation or location relationship indicated by the terms, such as “length”, “width”, “up”, “down”, “front”, “back”, “left”, “right”, “vertical”, “horizontal”, “top”, “bottom”, “inner”, “external” etc., are based on the orientation or location relationship shown in the drawings, which are only for convenience of describing the present application and simplifying the description, but not to indicate or imply that the device or component has to be provided with a specific orientation, or constructed and operated in a specific orientation, therefore the orientation or location relationship should not be understood as limitation to the present application.

Additionally, in the description of the present application, “a plurality of” means two or at least two, unless otherwise specified.

The implementations of the present application will be described in detail below with reference to specific embodiments.

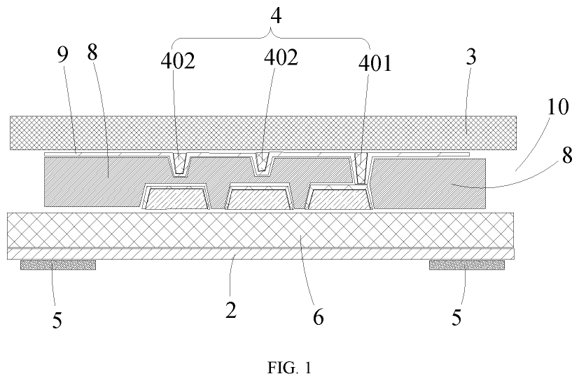

As shown in FIG. 1, an embodiment of the present application provides a display panel, which includes a color filter substrate 3, a spacer 4 disposed on the surface of the color filter substrate 3, a array substrate 6 arranged opposite to the color filter substrate 3, a first polarizer 2 arranged on a side of the array substrate 6 facing away from the color filter substrate 3, and a black matrix 5 arranged on a side of the first polarizer 2 facing away from the array substrate 6; the spacer 4 includes a main spacer 401 and a secondary spacer 402. In FIG. 1, the viewing position of human eyes corresponding to the display panel is below the array substrate 6.

In an embodiment of the present application, the black matrix 5 is arranged on the side of the first polarizer 2 facing away from the array substrate 6, the BPS (BM+PS) in the inner side of the color filter substrate merely requires producing the main spacer 401 and the secondary spacer 402, thus there is only one segmental difference between the main spacer 401 and the secondary spacer 402 in the inner side of the color filter substrate 3, and there is no segmental difference between the black matrix 5 and the secondary spacer 402, thereby solving the problem that the segmental difference between the secondary spacer 402 and the black matrix 5 is nonuniform. The above segmental difference in the middle of the color filter substrate may be easily generated by using a half tone mask, and the size of the segmental difference is easy to control, which can ensure consistent segmental difference everywhere. Moreover, that the black matrix 5 is arranged on the side of the first polarizer 2 facing away from the second polarizer 1 may be achieved through screen printing, the production process of which is easy, thus promoting the production rate of the products.

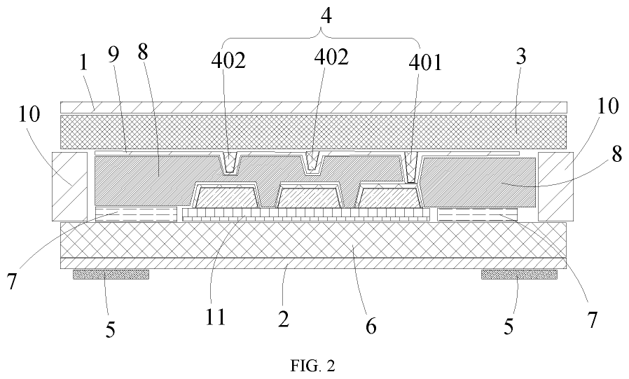

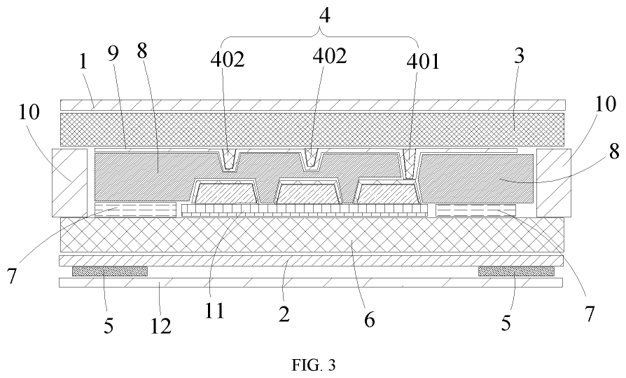

In an embodiment, please refer to FIG. 2 to FIG. 3, as a specific implementation of the display panel provided in the embodiment of the present application, the display panel further includes a second polarizer 1 disposed on a side of the color filter substrate 3 facing away from the array substrate 6, and an array substrate driving circuit 7 arranged on a side of the array substrate 6 facing toward the color filter substrate 3; the array substrate driving circuit 7 is formed by cascading n row driving elements of the array substrate, and each row driving element of the array substrate is provided with a capacitor, one terminal of the capacitor is connected to a gate signal point and another terminal is connected to a horizontal scanning line corresponding to the row driving element of the array substrate. The capacitor is configured to increase the potential of the gate signal point such that the row drive elements of the array substrate are in an open and output state. The array substrate 6 may be coated with an alignment layer for the alignment of the liquid crystal; two sides of the array substrate 6 may be provided with a groove or a projection structure to prevent the alignment fluid of the alignment layer from flowing out.

In an embodiment, please refer to FIG. 2 to FIG. 3, as a specific implementation of the display panel provided in the embodiment of the present application, the array substrate 6 is provided with a color resistance, and the surface of the color resistance is covered with a common electrode of the array substrate.

In an embodiment, please refer to FIG. 1, as a specific implementation of the display panel provided in the embodiment of the present application, the main spacer 401 and the secondary spacer 402 are disposed opposite to the color resistance.

In an embodiment, the main spacer 401 and the secondary spacer 402 respectively correspond to color resistances with different colors.

In an embodiment, the main spacer 401 corresponds to the color resistance, and the secondary spacer 402 corresponds to a region between adjacent color resistances.

In an embodiment, please refer to FIG. 2, as a specific implementation of the display panel provided in the embodiment of the present application, the thickness of the main spacer 401 is larger than the thickness of the secondary spacer 402, so as to achieve the segmental difference between the main spacer 401 and the secondary spacer 402 after the black matrix is arranged on the side of the first polarizer 2 facing away from the second polarizer 1.

In an embodiment, please refer to FIG. 2, as a specific implementation of the display panel provided in the embodiment of the present application, the display panel further includes the liquid crystal 8 between the color filter substrate 3 and the array substrate 6, and a transparent conductive film 9 disposed on the side of the color filter substrate 3 facing toward the liquid crystal 8. The liquid crystal 8 is filled between the color filter substrate 3 and the array substrate 6, and is departed from the color filter substrate 3 through the transparent conductive film 9.

In an embodiment, please refer to FIG. 2, as a specific implementation of the display panel provided in the embodiment of the present application, the transparent conductive film 9 covers the main spacer 401 and the secondary spacer 402. The above transparent conductive film 9 may be selected from an ITO (indium tin oxide) film.

In an embodiment, please refer to FIG. 2, as a specific implementation of the display panel provided in the embodiment of the present application, a sealing frame 10 is arranged between the edges of the color filter substrate 3 and the array substrate 6 for packaging the liquid crystal 8. The sealing frame 10, on the opposite sides of the liquid crystal 8, seals the liquid crystal 8 between the color filter substrate 3 and the array substrate 6.

In an embodiment, the thickness of all main spacers 401 is uniform.

In an embodiment, the thickness of all secondary spacers 402 is uniform.

In an embodiment, please refer to FIG. 2, as a specific implementation of the display panel provided in the embodiment of the present application, the display panel further includes a TFT array 11 disposed on a side of the liquid crystal 8 facing away from the transparent conductive film 9, and the TFT array 11 is arranged opposite to the color filter substrate 3.

As shown in FIG. 2, an embodiment of the present application provides the above display panel, the display panel includes: a second polarizer 1; a color filter substrate 3 arranged on a side of the second polarizer 1, and the surface of the color filter 3 is provided with a transparent conductive film 9; a spacer 4 arranged on a side of the color filter substrate 3 facing away from the second polarizer 1, the spacer 4 includes a main spacer 401 and a secondary spacer 402, the height of the main spacer 401 is larger than the height of the secondary spacer 402, and the transparent conductive film 9 covers the spacer 4; an array substrate 6 arranged opposite to the color filter substrate, the surface of the array substrate 6 is provided with an array substrate driving circuit 7 and a color resistance, the surface of the color resistance is provided with a common electrode of the array substrate, and at least one main spacer 401 pushes the transparent conductive film 9 to be connected with the array substrate through the common electrode; a first polarizer 2 disposed on a side of the array substrate 6 facing away from the color filter substrate 3; and a black matrix 5 disposed on a side of the first polarizer 2 facing away from the array substrate.

The black matrix 5 is arranged on the side of the first polarizer 2 facing away from the array substrate 6 in the present application, the BPS (BM+PS) in the inner side of the color filter substrate merely requires producing the main spacer 401 and the secondary spacer 402, thus there is only one segmental difference between the main spacer 401 and the secondary spacer 402 in the inner side of the color filter substrate 3, and there is no segmental difference between the black matrix 5 and the secondary spacer 402, thereby solving the problem that the segmental difference between the secondary spacer 402 and the black matrix 5 is nonuniform. Since at least one main spacer 401 pushes the transparent conductive film 9 to be connected with the array substrate through the common electrode, the conduction between the upper circuit and the lower circuit can be achieved through the spacer directly, and no additional conduction structure is required.

As shown in FIG. 3, an embodiment of the present application provides a display device, the display device includes the above display panel and other necessary elements, such as a backlight module 12. The backlight module 12 is arranged on a side of the black matrix 5 facing away from the first polarizer 2.

Obviously, the above embodiments of the present application are merely examples for clearly describing the present invention and are not intended to limit the implementations of the present application. Other variations or modifications with various forms may be made based on the above description by those skilled in the art. There is no need and no way to exhaust all of the implementations. Any modifications, equivalent substitutions and improvements made within the spirit and principle of the present application are intended to be included within the scope of the appended claims.

What is claimed is:

1. A display panel, comprising:
a color filter substrate;
a spacer disposed on the surface of the color filter substrate, wherein the spacer comprises a main spacer and a secondary spacer;
an array substrate arranged opposite to the color filter substrate;
a first polarizer arranged on a side of the array substrate facing away from the color filter substrate; and
a black matrix arranged on a side of the first polarizer facing away from the array substrate.

2. The display panel according to claim 1, wherein the display panel further comprises:
a second polarizer disposed on a side of the color filter substrate facing away from the array substrate; and
an array substrate driving circuit arranged on a side of the array substrate facing toward the color filter substrate.

3. The display panel according to claim 2, wherein the array substrate is provided with a color resistance, and the array substrate driving circuit covers the color resistance.

4. The display panel according to claim 3, wherein the main spacer and the secondary spacer are arranged opposite to the color resistance.

5. The display panel according to claim 4, wherein the main spacer and the secondary spacer correspond to the color resistances with different colors.

6. The display panel according to claim 3, wherein the main spacer corresponds to the color resistance, and the secondary spacer corresponds to a region between adjacent color resistances.

7. The display panel according to claim 1, wherein the thickness of the main spacer is larger than the thickness of the secondary spacer.

8. The display panel according to claim 1, wherein the display panel further comprises liquid crystal disposed between the color filter substrate and the array substrate, and a transparent conductive film disposed on a side of the color filter substrate facing toward the liquid crystal.

9. The display panel according to claim 8, wherein the transparent conductive film covers the main spacer and the secondary spacer.

10. The display panel according to claim 8, wherein a sealing frame is arranged between the edges of the color filter substrate and the array substrate for packaging the liquid crystal.

11. The display panel according to claim 1, wherein all the thickness of the main spacer is uniform, and all the thickness of the secondary spacer is uniform.

12. A display device, comprising:
a color filter substrate;
a spacer disposed on the surface of the color filter substrate, wherein the spacer comprises a main spacer and a secondary spacer;
an array substrate arranged opposite to the color filter substrate;
a first polarizer arranged on a side of the array substrate facing away from the color filter substrate;
a black matrix arranged on a side of the first polarizer facing away from the array substrate; and
a backlight module arranged on a side of the black matrix facing away from the first polarizer.

13. The display device according to claim 12, wherein the display device further comprises:
a second polarizer disposed on a side of the color filter substrate facing away from the array substrate; and
an array substrate driving circuit arranged on a side of the array substrate facing toward the color filter substrate.

14. The display device according to claim 13, wherein the array substrate is provided with a color resistance, and the surface of the color resistance is provided with a common electrode of the array substrate.

15. The display device according to claim 12, wherein the thickness of the main spacer is larger than the thickness of the secondary spacer.

16. The display panel according to claim 15, wherein, the main spacer and the secondary spacer are arranged opposite to the color resistance, the main spacer and the secondary spacer correspond to the color resistances with different colors; or
the main spacer corresponds to the color resistance, and the secondary spacer corresponds to a region between adjacent color resistances.

17. The display device according to claim 12, wherein the display device further comprises liquid crystal disposed between the color filter substrate and the array substrate, and a transparent conductive film disposed on a side of the color filter substrate facing toward the liquid crystal.

18. The display device according to claim 17, wherein the transparent conductive film covers the main spacer and the secondary spacer.

19. The display device according to claim 17, wherein a sealing frame is arranged between the edges of the color filter substrate and the array substrate for packaging the liquid crystal.

20. A display panel, comprising:
a color filter substrate, the surface of which is provided with a transparent conductive film;
an array substrate arranged opposite to the color filter substrate, wherein the surface of the array substrate is provided with an array substrate driving circuit and a color resistance, the surface of the color resistance is provided with a common electrode of the array substrate;
a first polarizer arranged on a side of the array substrate facing away from the color filter substrate;
a black matrix arranged on a side of the first polarizer facing away from the array substrate;
a second polarizer disposed on a side of the color filter substrate facing away from the array substrate; and
a spacer arranged on a side of the color filter substrate facing away from the second polarizer, wherein the spacer comprises a main spacer and a secondary spacer, wherein the height of the main spacer is larger than the height of the secondary spacer, the transparent conductive film covers the spacer, and at least one main spacer pushes the transparent conductive film to be to be connected with the array substrate through the common electrode.
